(19) United States
(12) Patent Application Publication
(10) Pub. No.: US 2024/0265431 A1
(43) Pub. Date: Aug. 8, 2024

(54) METHODS, SYSTEMS, ARTICLES OF MANUFACTURE AND APPARATUS FOR LEXICAL ANALYSIS

(71) Applicant: Nielsen Consumer LLC, Chicago, IL (US)

(72) Inventors: David Jiménez Cabello, Lupiana (ES); Mario Almagro, Valdemoro (ES); Emilio Javier Almazan, Alcorcon (ES); Diego Ortego Hernández, Alcobendas (ES)

(21) Appl. No.: 18/341,463

(22) Filed: Jun. 26, 2023

Related U.S. Application Data
(60) Provisional application No. 63/482,851, filed on Feb. 2, 2023.
(60) Provisional application No. 63/482,955, filed on Feb. 2, 2023.

(51) Int. Cl. G06Q 30/0601; G06N 7/01

(52) U.S. Cl. CPC G06Q 30/0629; G06N 7/01

(57) ABSTRACT

Systems, apparatus, articles of manufacture, and methods are disclosed for lexical analysis. An example apparatus includes interface circuitry, machine readable instructions, and programmable circuitry to at least one of instantiate or execute the machine readable instructions to encode tokens with token semantic characteristics, encode the tokens with token lexical characteristics to generate encoded tokens, respective ones of the encoded tokens including at least one of the semantic characteristics and at least one of the lexical characteristics, and identify a match between two of the encoded tokens.

### RELATED APPLICATION

This patent claims the benefit of U.S. Provisional Patent Application No. 63/482,851, which was filed on Feb. 2, 2023. This patent also claims the benefit of U.S. Provisional Patent Application No. 63/482,955, which was filed on Feb. 2, 2023. U.S. Provisional Patent Application No. 63/482,851 and U.S. Provisional Patent Application No. 63/482,955 are hereby incorporated herein by reference in its entirety. Priority to U.S. Provisional Patent Application No. 63/482,851 and U.S. Provisional Patent Application No. 63/482,955 is hereby claimed.

### FIELD OF THE DISCLOSURE

This disclosure relates generally to neural networks and, more particularly, to methods, systems, articles of manufacture and apparatus for lexical analysis by neural networks.

### BACKGROUND

In recent years, data associated with market activity has become readily available for analysis. Computational efforts assist with analysis of such voluminous data to determine related information.

### BRIEF DESCRIPTION OF THE DRAWINGS

FIG. 1A is a block diagram of an example environment including example comparison circuitry constructed in accordance with teachings of this disclosure to improve similarity assessments.

FIG. 1B is a block diagram of an example cross encoder framework to improve similarity assessments.

FIG. 2 is a flowchart representative of example machine readable instructions and/or example operations that may be executed by example processor circuitry to implement the comparison circuitry and/or frameworks of FIGS. 1A and 1B.

FIG. 3 is a block diagram of an example processing platform including programmable circuitry structured to execute, instantiate, and/or perform the example machine readable instructions and/or perform the example operations of FIG. 2 to implement the comparison circuitry of FIGS. 1A and 1B.

FIG. 4 is a block diagram of an example implementation of the programmable circuitry of FIG. 3.

FIG. 5 is a block diagram of another example implementation of the programmable circuitry of FIG. 3.

FIG. 6 is a block diagram of an example software/firmware/instructions distribution platform (e.g., one or more servers) to distribute software, instructions, and/or firmware (e.g., corresponding to the example machine readable instructions of FIG. 2) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

E-commerce websites offer hundreds of millions of products as a result of the online expansion of retailers' businesses. In this context, performing product matching successfully (e.g., finding offers from different data sources referring to the same product) is a valuable business capability. In some examples, this process is referred to herein as “cross-coding” and enables data scientists, retailers, market researchers, etc., to understand sales trends using a product taxonomy.

The product matching task is particularly challenging due to the large number of existing products, their high heterogeneity, missing product information, and varying levels of data quality. For instance, consider two product descriptions for the same product: (1) “dog food organix grain free ch,” and (2) “c&p ckn veg dg fd og”, which are a pair of product offer sentences that are to be matched in a particular nomenclature domain (e.g., a database of product SKUs and associated characteristics). One limiting factor for traditional computational approaches is the lexical diversity observed in product descriptions, with a high presence of typos and abbreviations coming from different data sources. As used herein, “lexical” analysis relates to characteristics of words, groups of words, and/or vocabulary in a manner distinguished from grammatical and/or syntax characteristics of such words. For instance, the second product offer sentence above uses an abbreviation of “ckn,” which is a clear syntax error when compared to the intended term “chicken.” However, as distinguished from syntax inconsistencies that prevent computational comparisons, example lexical characteristics disclosed herein help to generate a likelihood that the term “ckn” and “chicken” are intended to mean the same thing.

Previous works attempt to mitigate this type of noise using data augmentation or knowledge distillation techniques at the expense of a higher computational cost. Other methods address the problem using regularization techniques for the tokenization in an effort to cause greater diversity during token pattern identification, which prevents undesirable overfitting and improved word variability. As a result, regularization techniques cause a greater degree of robustness in connection with lexical changes. In some examples, regularization techniques focus on subword regularization techniques that randomly split words into relatively less frequent units.

In examples disclosed herein, enhancements of a self-attention mechanism of transformer architectures with a particular cross-attention network that accounts for the lexical similarity between words in pairs of descriptions are described. Examples disclosed herein enable models to pay attention to similar words in two sentences (or other word groupings) to be compared from a lexical perspective. As a result, example models trained with these techniques show improved robustness under the presence of typos and abbreviations while keeping performance in clean cases (e.g., cases in which no typographical errors or abbreviations are used). In other words, examples disclosed herein analyze textual similarity information in the attention models to improve the robustness of transformer architectures under the presence the lexical noise.

The e-commerce domain often exhibits the usage of noisy language when describing the information of products. Common observations include a regular presence of typos (e.g., keyboard or OCR induced errors), non-conventional abbreviations and extremely short text, which poses challenges to applying machine learning (ML) solutions to learn representations of products for downstream tasks (e.g., matching, classification).

A lexical diversity of e-commerce language and/or terminology, given by the different type descriptions of different data sources (e.g., different retailers might describe the same product using different descriptions), increases the complexity of the ML input space. Thus, ML models require large amounts of data to achieve competitive learning. At the same time, the lack of context and the presence of typos and abbreviations (e.g., custom abbreviations created by particular retailers) in product descriptions further complicates the problem by providing even less information for their characterization. Based on these circumstances, examples disclosed herein include new algorithms that help ML models to learn robust product representations from highly compressed text.

Without the benefit of examples disclosed herein, shipping and/or re-stocking efforts fail to meet expectations of demand corresponding to regions of interest. For instance, while receipt data for a particular region of interest may be abundant and provide indications of particular product sales volumes, if the product nomenclature includes typographical errors or abbreviations that are not consistent with other regions of interest, some product volume metrics may be inaccurate. To illustrate, first receipts that identify a product as “Coke 220 mL” in a first geographic region of interest may be compared to any number of second receipts that identify a product as “Cok 220 mL”. Because the first receipts do not use shorthand for the product name “Coke”, the corresponding count of purchase instances enables retailers and/or product suppliers in the first region of interest to properly stock that product in view of demand behaviors. However, because the second receipts use a shorthand “Cok” (without the letter “e”), neural network transformer analysis on such receipts fails to correctly and/or otherwise accurately associate the receipt purchase instance with the corresponding product. Comparison between the nomenclature of the first and second receipts results in a non-match. In other environments, without the benefit of examples disclosed herein medication prescribed by a physician at a first time may differ from medication delivered to a particular patient when ambiguity is introduced by handwriting imperfections, shorthand notation and/or spelling errors.

Examples disclosed herein reduce the errors in prescriptions and/or receipts of neural network transformers by including a lexical bias to aid in one or more semantic (e.g., syntax) analysis techniques employed by self attention networks. As such, the disclosed subject matter improves a technology and/or technological process.

In some scenarios, two types of architectures dominate: bi-encoders and cross-encoders. The former focuses on efficiency, learning meaningful representations (e.g., a product sentence description, a product word grouping, etc.) for each product independently and without accounting for the relative differences between the representations of other product representations to be compared. On the other hand, the latter (i.e., cross-encoders) processes a pair of representations (e.g., a sentence description) substantially simultaneously and/or otherwise in view of each other, thereby exploiting a higher computational capacity by processing co-dependencies via self-attention mechanisms. Both architectures encode data in lexical units, or tokens, creating a vocabulary of encoded tokens. Such tokens have been generated by extracting the most frequent patterns in the vocabulary of the training data, normally considering sub-word information. For example, frequently used words such as “hospital” are maintained without any modification, whereas less frequent words, such as “hospitalization” are decomposed as: “hospital”+“ization”.

As described above, despite a wide environmental applicability with examples disclosed herein (e.g., medical safety, e-commerce, retailer, sales merchant, etc.), particular examples disclosed herein focus on the product matching task, whose objective is to discriminate whether two descriptions refer to the same product identifier or not, e.g., “Coca-cola 330 ml pack 6” matches “coke 330 pck 6” but is different to “coca-cola 21”. While examples disclosed herein relate to product matching within a retail environment, examples disclosed herein are not limited thereto. As described above, examples disclosed herein may be implemented in any environment or circumstance in which text information is to be compared to determine a match or substantial parity. For instance, a physician order for a specific medication in a medical records database at a first time should be compared to text information on drug packaging (e.g., via camera scanner devices) at a second time before another medical professional administers the medication to a patient (e.g., in a hospital room of the patient). Stated differently, examples disclosed herein enable life-saving improvements to technologies associated with data verification and/or matching. Examples disclosed herein present LExical-aware cross-Attention (LEA) models (e.g., algorithms, circuits, model frameworks, etc.) for cross-encoders that exploit the lexical similarity between two product descriptions, helping transformer-based architectures to improve robustness to typos and abbreviations.

Examples disclosed herein enhance the self-attention originally based solely on semantic similarities with lexical similarities. For instance, words that the model struggles to relate semantically like “chocolate” and “choc” are correctly matched and/or otherwise associated by example lexical models disclosed herein.

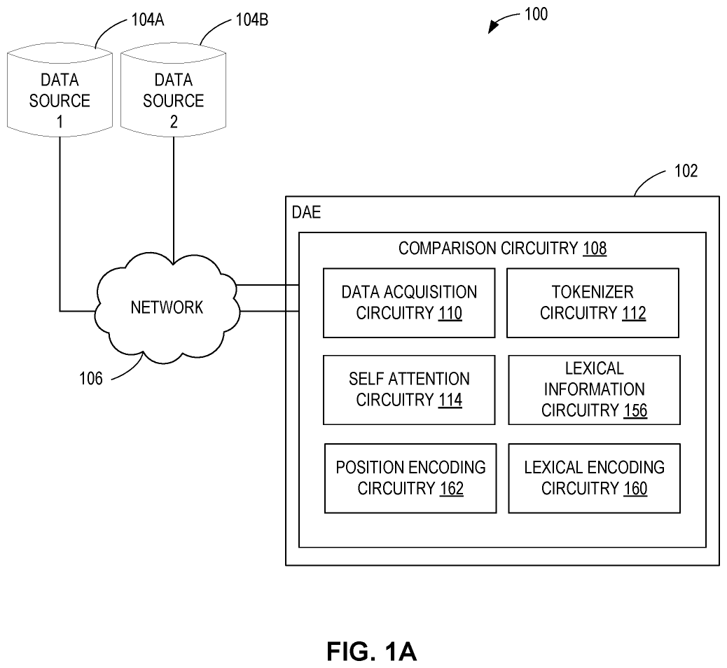

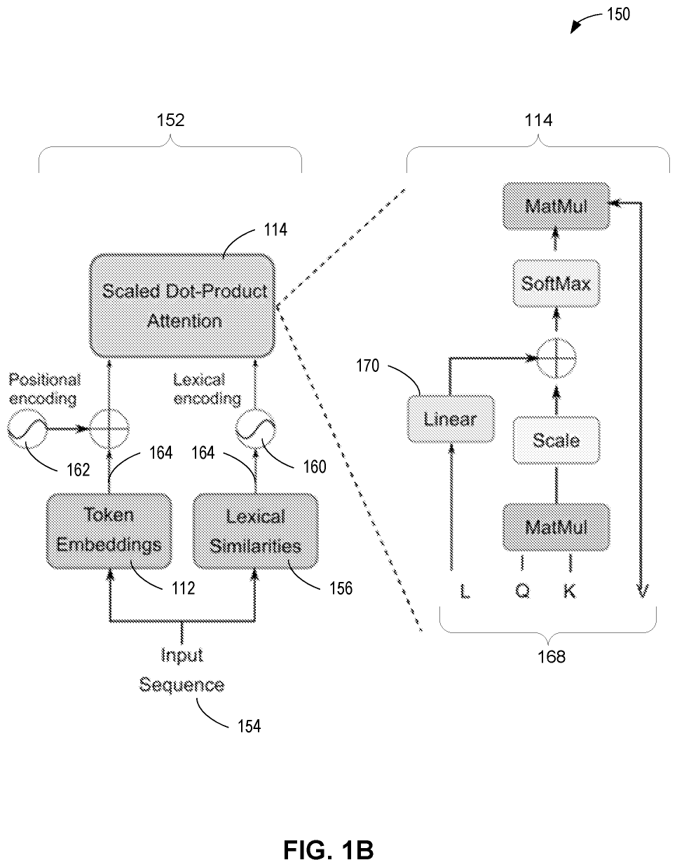

FIG. 1A is a block diagram of an example environment 100 constructed in accordance with teachings of this disclosure for improving similarity assessments. The comparison circuitry 108 of FIG. 1A may be instantiated (e.g., creating an instance of, bring into being for any length of time, materialize, implement, etc.) by programmable circuitry such as a Central Processor Unit (CPU) executing first instructions. Additionally or alternatively, the comparison circuitry 108 of FIG. 1A may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1A may, thus, be instantiated at the same or different times. Some or all of the circuitry of FIG. 1A may be instantiated, for example, in one or more threads executing concurrently on hardware and/or in series on hardware. Moreover, in some examples, some or all of the circuitry of FIG. 1A may be implemented by microprocessor circuitry executing instructions and/or FPGA circuitry performing operations to implement one or more virtual machines and/or containers.

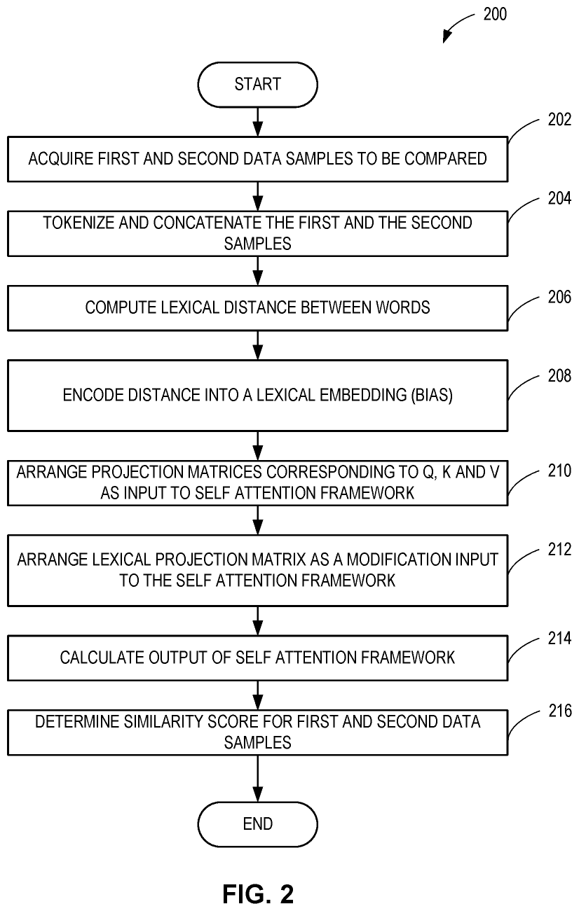

The environment 100 of FIG. 1A includes an example data analysis entity (DAE) 102. In some examples, the DAE 102 is a market research entity to analyze textual inputs corresponding to retail product descriptions, and in some examples the DAE 102 is a medical safety entity to compare physician-ordered medications with corresponding distribution occurrences to make sure patients do not receive erroneous medications. In either case, the example DAE 102 is an entity that collects and analyzes data (e.g., market data, drug data, etc.) to generate actionable insights. In some examples, the DAE 102 of FIG. 1A is implemented by one or more servers. For example, the DAE 102 can be a physical processing center including servers. In some examples, at least some functionality of the DAE 102 is implemented via an example cloud and/or Edge network (e.g., AWS®, etc.). For example, the DAE 102 may include a cloud-based architecture that integrates data assets and analytics into a platform. In some examples, the DAE 102 is absent. For example, the functionality of the DAE 102 may implemented by any suitable device or combination of devices. In some examples, the DAE 102 is instantiated by programmable circuitry executing DAE instructions and/or configured to perform operations such as those represented by the flowchart of FIG. 2.

The environment 100 of FIG. 1A includes example data sources, such as an example first data source 104A and an example second data source 104B, which are communicatively coupled to the DAE 102 via an example network 106. In the example of FIG. 1A, the network 106 is the Internet. However, the example network 106 may be implemented using any other network over which data can be transferred. The example network 106 may be implemented using any suitable wired and/or wireless network(s) including, for example, one or more data buses, one or more Local Area Networks (LANs), one or more wireless LANs, one or more cellular networks, one or more private networks, one or more public networks, among others. In additional or alternative examples, the network 106 is an enterprise network (e.g., within businesses, corporations, etc.), a home network, among others.

The example DAE 102 includes example comparison circuitry 108 to improve similarity assessments by neural networks. In some examples, the comparison circuitry 108 is instantiated by programmable circuitry executing comparison instructions and/or configured to perform operations such as those represented by the flowchart of FIG. 2.

The example comparison circuitry 108 includes example data acquisition circuitry 110 to acquire data samples of interest. As described in further detail below, in some examples the data acquisition circuitry 110 acquires strings of product descriptions from one or more data sources. In some examples, the data acquisition circuitry 110 acquires strings of prescribed medications from one or more sources. In some examples, the data acquisition circuitry 110 is instantiated by programmable circuitry executing data acquisition instructions and/or configured to perform operations such as those represented by the flowchart(s) of FIG. 2.

The example comparison circuitry 108 includes example tokenizer circuitry 112 to tokenize acquired text data. In some examples, the tokenizer circuitry 110 is instantiated by programmable circuitry executing tokenizer and/or token encoding instructions and/or configured to perform operations such as those represented by the flowchart(s) of FIG. 2.

The example comparison circuitry 108 includes example self attention circuitry 114 to calculate and/or otherwise introduce bias into tokens corresponding to textual inputs, as described in further detail below. In some examples, the self attention circuitry 114 is referred to herein as a self attention module, a self attention network, self attention bias circuitry, or a self attention framework. In some examples, the self attention circuitry 114 is instantiated by programmable circuitry executing self attention bias instructions and/or configured to perform operations such as those represented by the flowchart(s) of FIG. 2.

The example comparison circuitry 108 includes example lexical information circuitry 156 to calculate and/or otherwise determine lexical similarities between tokens (e.g., to determine lexical information corresponding to example input sequence(s)), as described in further detail below. In some examples, the lexical information circuitry 156 is instantiated by programmable circuitry executing lexical analysis instructions and/or configured to perform operations such as those represented by the flowchart(s) of FIG. 2.

The example comparison circuitry 108 includes example position encoding circuitry 162 to encode positional information in one or more tokens. In some examples, the position encoding circuitry 162 is instantiated by programmable circuitry executing position encoding instructions and/or configured to perform operations such as those represented by the flowchart(s) of FIG. 2.

The example comparison circuitry 108 includes example lexical encoding circuitry 160 to calculate and/or otherwise determine normalized edit distances between tokens (e.g., words within sentences). In some examples, the lexical encoding circuitry 160 is instantiated by programmable circuitry executing lexical encoding instructions and/or configured to perform operations such as those represented by the flowchart(s) of FIG. 2.

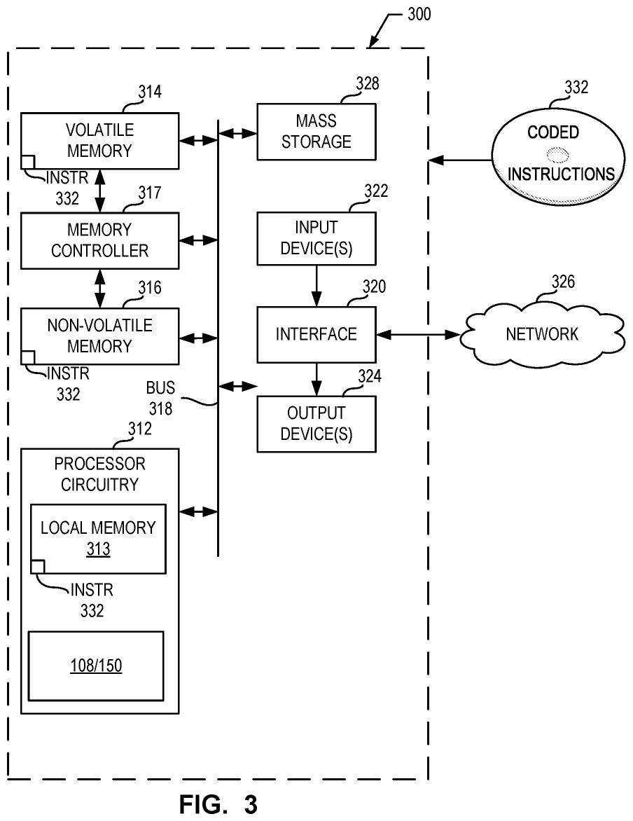

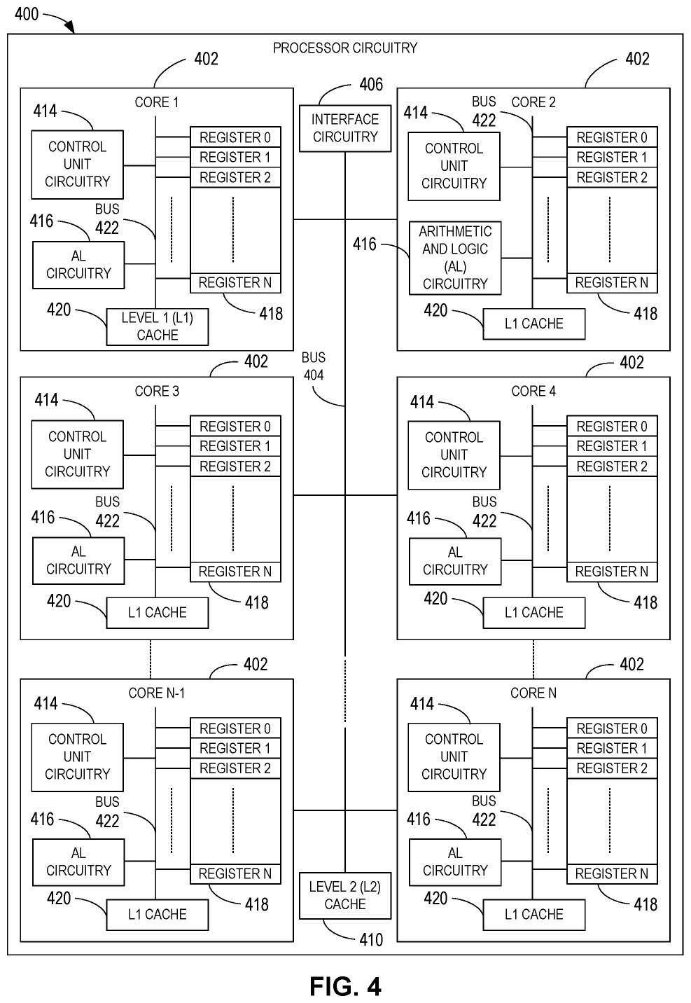

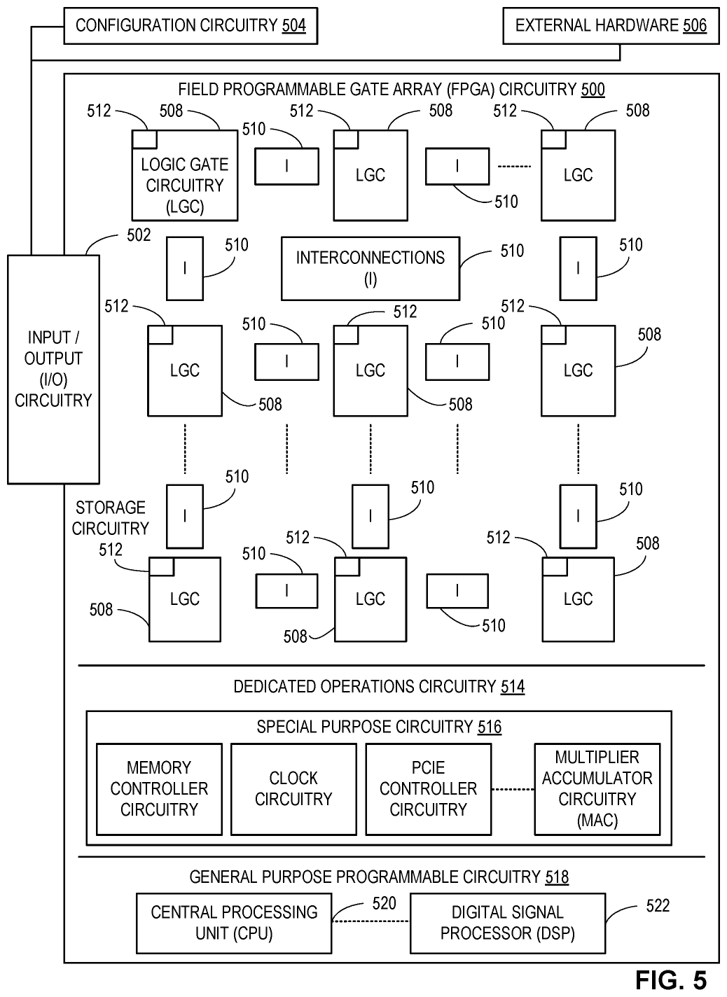

In some examples, the comparison circuitry includes means for comparing textual input. In some examples, the comparison circuitry includes means for acquiring data. In some examples, the comparison circuitry includes means for tokenizing. In some examples, the comparison circuitry includes means for self attention analysis. In some examples, the comparison circuitry includes means for lexical information analysis. In some examples, the comparison circuitry includes means for positional encoding. In some examples, the comparison circuitry includes means for lexical encoding. For example, the means for comparing textual input may be implemented by example comparison circuitry 108, and the means for acquiring data may be implemented by example data acquisition circuitry 110, and the means for tokenizing may be implemented by example tokenizer circuitry 112, and the means for self attention analysis may be implemented by example self attention circuitry 114, and the means for positional encoding may be implemented by example position encoding circuitry 162, and the means for lexical information may be implemented by example lexical information circuitry 156, and the means for lexical encoding may be implemented by example lexical encoding circuitry 160. In some examples, the aforementioned circuitry may be instantiated by programmable circuitry such as the example programmable circuitry 312 of FIG. 3. For instance, the aforementioned circuitry may be instantiated by the example microprocessor 400 of FIG. 4 executing machine executable instructions of FIG. 2. In some examples, the aforementioned circuitry may be instantiated by hardware logic circuitry, which may be implemented by an ASIC, XPU, or the FPGA circuitry 500 of FIG. 5 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In operation, the example comparison circuitry 108 facilitates and/or otherwise instantiates an example cross encoder framework 150 shown in the illustrated example of FIG. 1B. In some examples, the cross encoder framework 150 of FIG. 1B is referred to herein as a cross-attention circuit, cross-attention circuitry, cross encoder circuitry and/or, more generally, a cross encoder.

The example cross encoder framework 150 of FIG. 1B includes an example transformer 152, which is a type of neural network and/or framework that contains and/or otherwise includes data acquisition circuitry 110 (to accept input sequence information, such as previous layers of a neural network), lexical information circuitry 156 (e.g., to determine and/or otherwise calculate lexical information corresponding to example input sequence(s) 154), and tokenizer circuitry 112. The output of the example lexical information circuitry 156 and the example tokenizer circuitry 112 generates data structures referred to as attention outputs 164, as described in further detail below. The example cross encoder circuitry 150 also includes lexical encoding circuitry 160, position encoding circuitry 162, and example self attention circuitry 114 (e.g., sometimes referred to as a semantic neural network to determine semantic information). In some examples, the self attention circuitry 114 is referred to herein as a self attention circuit or a self attention framework.

An exploded view of the example self attention circuitry 114 is shown on the right hand side of FIG. 1B. The example self attention circuitry 114 includes vector representations 168 (e.g., derived from iterations of attention outputs 164) of query (Q), key (K) and value (V) projection matrices that are learned during one or more training iterations. However, unlike typical self attention circuitry implementations, examples disclosed herein include a lexical bias projection matrix 170 to improve robustness against textual noise without penalizing performance results when such noise does not exist in the input sequence(s) 154.

In operation, a concatenation of two sentence representations Xₗ and Xᵣ, for left and right sentences, respectively, are fed into the example cross encoder circuitry 150. Traditional cross encoder implementations attempt to derive semantic similarities between inputs to discern a match or non-match. In the absence of textual noise, such as typographical errors or nomenclature shorthand differences, the traditional cross encoders may provide output results that satisfy industry expectations. Stated differently, traditional cross encoder implementations, when viewed as a technological tool to identify matches between inputs, will operate well only when input sequence data is cleaned to prohibit typographical errors and nomenclature shorthand. As such, technologies and technological processes corresponding to traditional cross encoder implementations require one or more input pre-processing effort(s) so that input data is suitable for accurate output. Stated differently, pre-processing tasks require computational resources to scan and/or otherwise analyze all inputs to identify instances of typographical errors and/or nomenclature deviations. Examples disclosed herein reduce and/or otherwise eliminate a need to apply these pre-processing computational resources.

Real world inputs, on the other hand, typically include typographical errors that are caused by, for example, crumpled receipts, incoherent handwriting by physicians, blurry receipts, poor image capture (e.g., shaky camera artifacts), poor lighting conditions during image capture, typing input errors, etc. Additionally, real world operation of product nomenclature assignment is not standardized among retailers. Similarly, shorthand references for particular medications may differ between physicians and pharmaceutical nomenclature. Medication errors can occur when medications have similar-looking or similar-sounding names (e.g., “look-alike, sound-alike (LASA) errors). In examples related to retail environments, a first retailer may generate product codes to be printed on customer receipts when products are purchased. That first retailer has the discretion to utilize any shorthand representations of the product name in an effort to (a) allow the consumer/purchaser to understand what product was purchased when reading the receipt and (b) permit the product name to fit within the boundaries of the physical receipt. For instance, retailers that have a relatively wide physical receipt may enjoy the luxury of additional product description nomenclature to fully articulate the product (e.g., “Coke—6-pack”). On the other hand, a second retailer may implement a physical receipt that is relatively narrow when compared to the first retailer's receipt format. The second retailer may abbreviate the product name in a manner that permits it to fit (e.g., “Cok 6 pk”). As such, traditional techniques suffer from errors caused by humans and/or human discretion.

When tokens are generated from input sequences, the tokenized representations are different when a single character is changed. As such, the tokenized representation for “Coke” is substantially different than the tokenized representation for “Cok” (e.g., without the “e” character). For example, in the event a tokenizer uses a concatenation of ASCII (American Standard Code for Information Interchange), then “Coke” results in an ASCII value of 386 (i.e., “C”=67, “o”=111, “k”=107, “e”=101). On the other hand, the word “Cok” (without the “e” at the end) results in an ASCII value of 285. While the above discussion corresponding to ASCII codes illustrates how substantial numerical representation differences may result from minor word variations, other tokenizers may take one or more alternate approaches in determining numerical representations of words, terms and/or sentences. In some examples, tokenizers assign integers as identifiers to subwords. Additionally, frequency statistics are calculated by tokenizers to determine particular subwords in which a word may be divided. Similar to the ASCII example above, a single character difference can lead to completely different splits, such as different identifiers with no direct connection therebetween.

From a machine/computer point of view, two separate values are necessarily distinguished therebetween when they differ by even a single integer value, despite the apparent semantic similarity appreciated by a human interpretation. Resulting cross encoder efforts to identify whether these two representations refer to the same product fail based on these radically different token representations. As discussed above, while the human interpretation between these two terms illustrates a substantial lexical similarity, traditional cross encoders, transformers and/or neural networks do not consider such lexical input when attempting to determine similarity between input(s). Examples disclosed herein improve the technology of data matching by calculating and introducing a lexical bias (e.g., token semantic characteristics combined with token semantic characteristics) to improve a technical performance of transformers and cross encoders.

The example cross encoder framework 150 of FIG. 1B learns token dependencies and decodes contextual information from the input sequence 154. The example lexical information circuitry 156 and/or the example tokenizer circuitry 112 receives an input sequence of n token representations from a previous layer X (in which the layer X includes any number of tokens xₙ) in a manner consistent with example Equation 1.

$$X = ( {x}_{1} , … , {x}_{n} ) . \qquad Equation 1$$

In the illustrated example of Equation 1, xᵢ∈ [symbol] ^{D}^{ₕ} and the tokenizer embedding circuitry 112 computes a new sequence in a manner consistent with example Equation 2, which has the same length and hidden dimension Dₕ. In particular, Dₕ represents a size of the dimensionality of the token embeddings that are defined in a first layer of the model. In some examples, the dimensionality size Dₕ reflects values that are linked to a particular architecture type used, such as a value of Dₕ=512 to define token embeddings in connection with a BERT-Medium language model.

$$Z = ( {z}_{1} , … , {z}_{n} ) . \qquad Equation 2$$

For simplicity, example equations disclosed herein refer to a single layer and attention head. Generally speaking, the attention head is a layer (sometimes referred to as a module) that is part of the transformer architecture in which Query, Key, and Value parameters are learned to weigh the relevance of each token of a description based on semantic similarity. As such, it generates a matrix of K×K tokens. Each layer includes any number of attention heads and as a result of the attention layer, representations of each token at the output are combinations of input representations in which each token is weighed with the relevance values. For example, if a sentence includes five (5) tokens, an attention layer (e.g., layer N) computes the relevance of each of the five tokens for the first token using the embeddings from that layer. Accordingly, each attention head has the ability to encode multiple relationships and nuances for each token. Typical cross encoders generate an output (zᵢ) of their respective self attention circuits in a manner consistent with example Equation 3.

$${z}_{i} = {\sum }_{j = 1}^{n} {∝}_{ij} ( {x}_{j} \cdot {W}^{V} ) . \qquad Equation 3$$

In the illustrated example of Equation 3, Wv represents a projection matrix (e.g., a value projection matrix) of learned values to generate a new linear combination of the attention scores, and each new token representation zᵢ is a weighted average of linearly projected token representations xⱼ, ∀jϵ[1, n]. The weight αᵢⱼ associated with each pair of tokens is computed (e.g., by the self attention circuitry 114) in a manner consistent with example Equation 4 (e.g., a soft-max function).

$${∝}_{ij} = \frac{exp {e}_{ij}}{{\sum }_{k = 1}^{n} exp {e}_{ik}} . \qquad Equation 4$$

In the illustrated example of Equation 4, the self attention circuitry 114 computes the scalar eᵢⱼ using a compatibility function (e.g., dot product) between tokens i and j in the input sequence (e.g., a sentence) in a manner consistent with example Equation 5.

$${e}_{ij} = \frac{( {x}_{i} {W}^{Q} ) ( {x}_{j} {W}^{k} )}{\sqrt{{D}_{h}}} . \qquad Equation 5$$

As described above, the query (Q), key (K) and value (V) projection matrices {W^{Q}, W^{K}, W^{V}}ϵ [symbol] ^{Dh x Di} are learned during training, where Di refers to the dimension of the intermediate representations.

However, and as described above, traditional cross encoder approaches struggle with accuracy in the presence of textual noise, such as typographical errors and/or nomenclature discrepancies. In other words, the weighted average αᵢⱼ of the pair of tokens struggles at relating terms with noise given that minor deviations in a language representation cause substantial changes in the corresponding token representation. Examples disclosed herein employ new self attention circuitry 114 and/or lexical encoding circuitry 160 to facilitate normalized edit distances between words to provide the example cross encoder 150 of FIG. 1B with improved robustness and/or accuracy when noise is present between input sequence data 154 (e.g., sentences to compare, words to compare, etc.).

The example self attention circuitry 114 and/or the example lexical encoding circuitry 160 processes relative position embeddings in a manner consistent with example Equation 6, which is a further modification of example Equation 5 above.

$${\tilde{e}}_{ij} = {w}_{s} {e}_{ij} + {l}_{ij} {W}^{l} . \qquad Equation 6$$

In the illustrated example of Equation 6, wₛ and W^{l} are independent projections for the self-attention and the lexical bias, respectively, such that wₛ: [symbol] and Wl: [symbol] ^{Dlex}→ [symbol] . These projection layers, sometimes referred to as vector representations 168, are introduced to map the attention outputs 164 in a space where they can be combined. In particular, the example position encoding circuitry 162 calculates and/or otherwise generates token semantic characteristics of a set of tokens based on a semantic compatibility function. Such token semantic characteristics are encoded into a set of tokens by the example position encoding circuitry 162 so that they may later be combined with token lexical characteristics. The example cross encoder 150 measures pair-wise compatibility of lexical bias and uses a lexical embedding lᵢⱼϵ [symbol] ^{lxDlex} to encode lexical similarities into the tokens. In particular, a pair-wise lexical attention embedding generates and/or otherwise calculates token lexical characteristics, in which the lexical attention embedding is computed by the lexical encoding circuitry 160 by measuring a similarity between words that considers only inter-sentence relations (in which lexical similarities between words of a same sentence are set to zero) in a manner consistent with example Equation 7.

$${s}_{ij} = \{ \begin{matrix}Sim ( w ( {x}_{i} ) , w ( {x}_{j} ) ) , if {x}_{i} ∈ {X}_{l} and {x}_{j} ∈ {X}_{r} \\ or {x}_{i} ∈ {X}_{r} and {x}_{j} ∈ {X}_{l} \\ 0 , otherwise\end{matrix} . \qquad Equation 7$$

In the illustrated example of Equation 7, Xₗ and Xᵣ represent the pair of input sentences to compare, w(xᵢ) and w(xⱼ) denote the input textual word from the ith and jth tokens, respectively, and Sim(.,.) is a metric that measures the string similarity between two words.

In some examples, the lexical encoding circuitry 160 computes a Levenshtein distance between words considering only inter-relations, such as distances between words of the same sentence set to zero. As such, the example lexical information circuitry 156 calculates the distance in a manner consistent with example Equation 8.

$${d}_{ij} = Lev ( w ( {x}_{i} ) , w ( {x}_{j} ) ) . \qquad Equation 8$$

In the illustrated example of Equation 8, w(xᵢ) represents all tokens belonging to the same word identifier. The example lexical encoding circuitry 160 encodes distance dᵢⱼ into a lexical embedding with a sinusoidal function over sᵢⱼ in a manner consistent with example Equation 9 and Equation 10.

$${l}_{ij}^{( {d}_{ij} , 2 p )} = sin ( \frac{2 π \cdot {d}_{ij}}{{β}^{\frac{2 p}{{D}_{h}}}} ) . \qquad Equation 9$$

$${l}_{ij}^{( {d}_{ij} , 2 p + 1 )} = cos ( \frac{2 π \cdot {d}_{ij}}{{β}^{\frac{2 p}{{D}_{h}}}} ) . \qquad Equation 10$$

In the illustrated example of equations 9 and 10, β=10⁴ and the position of the lexical embedding is denoted by pϵ{0, . . . , Dₗₑₓ−1}. The final lexical embedding lᵢⱼ is the concatenation of the two sinusoidal embeddings corresponding to example Equation 10. Generally speaking, the result is an encoded set of tokens in which respective ones of the tokens include the lexical characteristics and the semantic characteristics. In some examples, the encoded set of tokens that include both lexical and semantic characteristics are referred to herein as a pair-wise compatibility set that resulted in a computed pair-wise compatibility metric. As disclosed above, the pair-wise compatibility metric is sometimes based on the Levenshtein distance between particular tokens of interest. Additionally, the lexical encoding circuitry 160 scales the similarity sᵢⱼ by 2π to cover a full range of sinusoidal functions, which results in embeddings that are more uniformly distributed across an output space. As such, application of these uniquely modified, generated and/or otherwise calculated tokens permits weight generation (e.g., a Softmax function) in a manner consistent with example Equation 4 that does not struggle with accuracy errors in view of typographical errors (e.g., and/or abbreviations) in source text. In some examples, a final activation function of the self attention circuitry 114 is used to normalize an output of compared tokens and provide one or more probability values of a match. Additionally, the example self attention circuitry 114 generates a probability output corresponding to two candidate tokens as an indication of similarity (e.g., match/non-match thresholds).

Returning to the illustrated example of FIG. 1A, in some examples of operation, the example data acquisition circuitry 110 acquires two data samples of interest, such as two strings of product description data from one or more data sources. For example, a first data sample may be a string of product nomenclature data from receipt data stored in the example first data source 104A, and a second data sample may be a string of product nomenclature data from a product database cultivated by a manufacturer (e.g., stored in the example second data source 104B). As described above, at least one objective of the example comparison circuitry is to determine whether the first and second data samples refer to the same product. Generally speaking, the manufacturer may distribute the product of interest to any number of retailers throughout a geographic region using a first product description. However, each of those retailers may choose to represent the product description on sales receipts using their own variation of the product description. As such, a one-to-one comparison does not readily illustrate sales of that product when analyzed by the manufacturer.

The example tokenizer circuitry 112 tokenizes (e.g., converts text words to numeric representations that can be read by machine learning systems) and concatenates the first and the second samples. Stated differently, the tokenizer circuitry 112 learns token dependencies based on the language input(s), which is a numerical format that can be processed by transformers, neural networks and, in particular, the example cross encoder circuitry 150 of FIG. 1B.

The example lexical information circuitry 156 determines lexical similarities by calculating normalized distances between words. In particular, the lexical information circuitry 156 computes a distance (e.g., a Levenshtein distance) between words in a manner consistent with example Equation 8 discussed above. Additionally, the lexical encoding circuitry 160 encodes the distance information into a lexical embedding (e.g., a lexical bias) in a manner consistent with Equations 9 and 10 above. In some examples, the lexical encoding circuitry 160 transmits encoded tokens to the self attention network 114, and in some examples, the position encoding circuitry 162 transmits encoded tokens to the self attention network 114 in an effort to generate a probability value.

The example self attention circuitry 114 arranges projection matrices corresponding to Query, Key and Value as inputs to the example self attention circuitry 114. As described above, an output to the self attention circuitry 114 is calculated in a manner consistent with example Equation 3, with the addition of the lexical bias calculated in a manner consistent with example Equation 6. Stated differently, the self attention circuitry 114 arranges lexical projection matrix information as a modification of the input that, in traditional approaches only includes syntax-based information. Such arrangement(s) are performed by the self attention circuitry 114 in a manner consistent with example Equation 6. As such, the self attention circuitry 114 is able to calculate an output of the self attention circuitry/framework 150 so that the example comparison circuitry 108 can determine a similarity score between the example input sequence 154.

While an example manner of implementing the comparison circuitry 108 of FIG. 1A is illustrated in FIGS. 1A and 1B, one or more of the elements, processes, and/or devices illustrated in FIGS. 1A and/or 1B may be combined, divided, re-arranged, omitted, eliminated, and/or implemented in any other way. Further, the example data acquisition circuitry 110, the example tokenizer circuitry 112, the example lexical information circuitry 156, the example lexical encoding circuitry 160, the example position encoding circuitry 162, the example self attention circuitry 114, and/or, more generally, the example comparison circuitry 108 of FIG. 1A, may be implemented by hardware alone or by hardware in combination with software and/or firmware. Thus, for example, any of the example data acquisition circuitry 110, the example tokenizer circuitry 112, the example lexical information circuitry 156, the example lexical encoding circuitry 160, the example position encoding circuitry 162, the example self attention circuitry 114, and/or, more generally, the example comparison circuitry 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example comparison circuitry 108 of FIG. 1A may include one or more elements, processes, and/or devices in addition to, or instead of, those illustrated in FIGS. 1A and/or 1B, and/or may include more than one of any or all of the illustrated elements, processes and devices.

A flowchart representative of example machine readable instructions, which may be executed by programmable circuitry to implement and/or instantiate the comparison circuitry 108 of FIGS. 1A and 1B and/or representative of example operations which may be performed by programmable circuitry to implement and/or instantiate the comparison circuitry 108 of FIGS. 1A and 1B, is shown in FIG. 2. The machine readable instructions may be one or more executable programs or portion(s) of one or more executable programs for execution by programmable circuitry such as the programmable circuitry 312 shown in the example processor platform 300 discussed below in connection with FIG. 3 and/or may be one or more function(s) or portion(s) of functions to be performed by the example programmable circuitry (e.g., an FPGA) discussed below in connection with FIGS. 4 and/or 5. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 2, many other methods of implementing the example comparison circuitry 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 2 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 2 is a flowchart representative of example machine readable instructions and/or example operations 200 that may be executed, instantiated, and/or performed by programmable circuitry to improve similarity assessments. The example machine-readable instructions and/or the example operations 200 of FIG. 2 begin at block 202, at which the data acquisition circuitry 110 acquires a first data sample and a second data sample to be compared. In some examples, each data sample is a linguistic sentence, phrase or word, such as a first sentence or phrase indicative of a prescription ordered by a physician at a first time during a consultation or exam. In some examples, prescriptions are stored in a medical facility database, such as the example first data source 104A of FIG. 1A. Other medical personnel may, at a second time after the first time, process the prescription to be administered to a patient. Such other medical personnel (e.g., other physicians, pharmacists, nursing staff, etc.) may read and/or otherwise process the prescription in an effort to complete the task of providing the patient with the prescribed medication. In the event the other medical personnel acquire the prescribed medication, it is delivered to the patient having medication information printed thereon (e.g., a pill container, a syringe, etc.) that is scanned by scanning technology in an effort to verify that the prescribed medication is the same as the administered medication.

The example tokenizer circuitry 112 tokenizes and concatenates the first and the second data samples (block 204), and the example lexical information circuitry 156 computes distance information corresponding to the tokenized data samples (block 206). As described above, in some examples the distance information is a Levenshtein distance. The example lexical encoding circuitry 160 encodes the distance information into a lexical embedding as a bias for the self attention circuitry 114 (block 208).

The example self attention circuitry 114 of FIG. 1A arranges projection matrices corresponding to query, key and value as inputs (block 210). The self attention circuitry 114 also arranges a lexical projection matrix 170 as a modification input to the self attention circuitry 114 (block 212) to facilitate the calculation of an output (block 214), such as an output of similarity probability values generated by a Softmax circuit and/or Softmax algorithm. The example comparison circuitry determines a similarity score for the first and second samples (block 216).

FIG. 3 is a block diagram of an example programmable circuitry platform 300 structured to execute and/or instantiate the example machine-readable instructions and/or the example operations of FIG. 2 to implement the comparison circuitry 108 of FIG. 1A. The programmable circuitry platform 300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 300 of the illustrated example includes programmable circuitry 312. The programmable circuitry 312 of the illustrated example is hardware. For example, the programmable circuitry 312 can be implemented by one or more integrated circuits, logic circuits, FPGAs, microprocessors, CPUs, GPUs, DSPs, and/or microcontrollers from any desired family or manufacturer. The programmable circuitry 312 may be implemented by one or more semiconductor based (e.g., silicon based) devices. In this example, the programmable circuitry 312 implements the example data acquisition circuitry 110, the example tokenizer circuitry 112, the example self attention circuitry 114, the example lexical information circuitry 156, the example position encoding circuitry 162, the example lexical encoding circuitry 160, and the example comparison circuitry 108.

The programmable circuitry 312 of the illustrated example includes a local memory 313 (e.g., a cache, registers, etc.). The programmable circuitry 312 of the illustrated example is in communication with main memory 314, 316, which includes a volatile memory 314 and a non-volatile memory 316, by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317. In some examples, the memory controller 317 may be implemented by one or more integrated circuits, logic circuits, microcontrollers from any desired family or manufacturer, or any other type of circuitry to manage the flow of data going to and from the main memory 314, 316.

The programmable circuitry platform 300 of the illustrated example also includes interface circuitry 320. The interface circuitry 320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 322 are connected to the interface circuitry 320. The input device(s) 322 permit(s) a user (e.g., a human user, a machine user, etc.) to enter data and/or commands into the programmable circuitry 312. The input device(s) 322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 324 are also connected to the interface circuitry 320 of the illustrated example. The output device(s) 324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 300 of the illustrated example also includes one or more mass storage discs or devices 328 to store firmware, software, and/or data. Examples of such mass storage discs or devices 328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 332, which may be implemented by the machine readable instructions of FIG. 2, may be stored in the mass storage device 328, in the volatile memory 314, in the non-volatile memory 316, and/or on at least one non-transitory computer readable storage medium such as a CD or DVD which may be removable.

FIG. 4 is a block diagram of an example implementation of the programmable circuitry 312 of FIG. 3. In this example, the programmable circuitry 312 of FIG. 3 is implemented by a microprocessor 400. For example, the microprocessor 400 may be a general-purpose microprocessor (e.g., general-purpose microprocessor circuitry). The microprocessor 400 executes some or all of the machine-readable instructions of the flowcharts of FIG. 2 to effectively instantiate the circuitry of FIG. 2 as logic circuits to perform operations corresponding to those machine readable instructions. In some such examples, the circuitry of FIGS. 1A and 1B is instantiated by the hardware circuits of the microprocessor 400 in combination with the machine-readable instructions. For example, the microprocessor 400 may be implemented by multi-core hardware circuitry such as a CPU, a DSP, a GPU, an XPU, etc. Although it may include any number of example cores 402 (e.g., 1 core), the microprocessor 400 of this example is a multi-core semiconductor device including N cores. The cores 402 of the microprocessor 400 may operate independently or may cooperate to execute machine readable instructions. For example, machine code corresponding to a firmware program, an embedded software program, or a software program may be executed by one of the cores 402 or may be executed by multiple ones of the cores 402 at the same or different times. In some examples, the machine code corresponding to the firmware program, the embedded software program, or the software program is split into threads and executed in parallel by two or more of the cores 402. The software program may correspond to a portion or all of the machine readable instructions and/or operations represented by the flowchart of FIG. 2.

The cores 402 may communicate by a first example bus 404. In some examples, the first bus 404 may be implemented by a communication bus to effectuate communication associated with one(s) of the cores 402. For example, the first bus 404 may be implemented by at least one of an Inter-Integrated Circuit (I2C) bus, a Serial Peripheral Interface (SPI) bus, a PCI bus, or a PCIe bus. Additionally or alternatively, the first bus 404 may be implemented by any other type of computing or electrical bus. The cores 402 may obtain data, instructions, and/or signals from one or more external devices by example interface circuitry 406. The cores 402 may output data, instructions, and/or signals to the one or more external devices by the interface circuitry 406. Although the cores 402 of this example include example local memory 420 (e.g., Level 1 (L1) cache that may be split into an L1 data cache and an L1 instruction cache), the microprocessor 400 also includes example shared memory 410 that may be shared by the cores (e.g., Level 2 (L2 cache)) for high-speed access to data and/or instructions. Data and/or instructions may be transferred (e.g., shared) by writing to and/or reading from the shared memory 410. The local memory 420 of each of the cores 402 and the shared memory 410 may be part of a hierarchy of storage devices including multiple levels of cache memory and the main memory (e.g., the main memory 314, 316 of FIG. 3). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 402 may be referred to as a CPU, DSP, GPU, etc., or any other type of hardware circuitry. Each core 402 includes control unit circuitry 414, arithmetic and logic (AL) circuitry (sometimes referred to as an ALU) 416, a plurality of registers 418, the local memory 420, and a second example bus 422. Other structures may be present. For example, each core 402 may include vector unit circuitry, single instruction multiple data (SIMD) unit circuitry, load/store unit (LSU) circuitry, branch/jump unit circuitry, floating-point unit (FPU) circuitry, etc. The control unit circuitry 414 includes semiconductor-based circuits structured to control (e.g., coordinate) data movement within the corresponding core 402. The AL circuitry 416 includes semiconductor-based circuits structured to perform one or more mathematic and/or logic operations on the data within the corresponding core 402. The AL circuitry 416 of some examples performs integer based operations. In other examples, the AL circuitry 416 also performs floating-point operations. In yet other examples, the AL circuitry 416 may include first AL circuitry that performs integer-based operations and second AL circuitry that performs floating-point operations. In some examples, the AL circuitry 416 may be referred to as an Arithmetic Logic Unit (ALU).

The registers 418 are semiconductor-based structures to store data and/or instructions such as results of one or more of the operations performed by the AL circuitry 416 of the corresponding core 402. For example, the registers 418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 418 may be arranged in a bank as shown in FIG. 4. Alternatively, the registers 418 may be organized in any other arrangement, format, or structure, such as by being distributed throughout the core 402 to shorten access time. The second bus 422 may be implemented by at least one of an I2C bus, a SPI bus, a PCI bus, or a PCIe bus.

Each core 402 and/or, more generally, the microprocessor 400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 400 is a semiconductor device fabricated to include many transistors interconnected to implement the structures described above in one or more integrated circuits (ICs) contained in one or more packages.

The microprocessor 400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 400, in the same chip package as the microprocessor 400 and/or in one or more separate packages from the microprocessor 400.

FIG. 5 is a block diagram of another example implementation of the programmable circuitry 312 of FIG. 3. In this example, the programmable circuitry 312 is implemented by FPGA circuitry 500. For example, the FPGA circuitry 500 may be implemented by an FPGA. The FPGA circuitry 500 can be used, for example, to perform operations that could otherwise be performed by the example microprocessor 400 of FIG. 4 executing corresponding machine readable instructions. However, once configured, the FPGA circuitry 500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 400 of FIG. 4 described above (which is a general purpose device that may be programmed to execute some or all of the machine readable instructions represented by the flowchart of FIG. 2 but whose interconnections and logic circuitry are fixed once fabricated), the FPGA circuitry 500 of the example of FIG. 5 includes interconnections and logic circuitry that may be configured, structured, programmed, and/or interconnected in different ways after fabrication to instantiate, for example, some or all of the operations/functions corresponding to the machine readable instructions represented by the flowchart of FIG. 2. In particular, the FPGA circuitry 500 may be thought of as an array of logic gates, interconnections, and switches. The switches can be programmed to change how the logic gates are interconnected by the interconnections, effectively forming one or more dedicated logic circuits (unless and until the FPGA circuitry 500 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 2. As such, the FPGA circuitry 500 may be configured and/or structured to effectively instantiate some or all of the operations/functions corresponding to the machine readable instructions of the flowchart of FIG. 2 as dedicated logic circuits to perform the operations/functions corresponding to those software instructions in a dedicated manner analogous to an ASIC. Therefore, the FPGA circuitry 500 may perform the operations/functions corresponding to the some or all of the machine readable instructions of FIG. 2 faster than the general-purpose microprocessor can execute the same.

In the example of FIG. 5, the FPGA circuitry 500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 500 of FIG. 5 may access and/or load the binary file to cause the FPGA circuitry 500 of FIG. 5 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 500 of FIG. 5 to cause configuration and/or structuring of the FPGA circuitry 500 of FIG. 5, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 500 of FIG. 5 may access and/or load the binary file to cause the FPGA circuitry 500 of FIG. 5 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 500 of FIG. 5 to cause configuration and/or structuring of the FPGA circuitry 500 of FIG. 5, or portion(s) thereof.

The FPGA circuitry 500 of FIG. 5, includes example input/output (I/O) circuitry 502 to obtain and/or output data to/from example configuration circuitry 504 and/or external hardware 506. For example, the configuration circuitry 504 may be implemented by interface circuitry that may obtain a binary file, which may be implemented by a bit stream, data, and/or machine-readable instructions, to configure the FPGA circuitry 500, or portion(s) thereof. In some such examples, the configuration circuitry 504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 506 may be implemented by external hardware circuitry. For example, the external hardware 506 may be implemented by the microprocessor 400 of FIG. 4.

The FPGA circuitry 500 also includes an array of example logic gate circuitry 508, a plurality of example configurable interconnections 510, and example storage circuitry 512. The logic gate circuitry 508 and the configurable interconnections 510 are configurable to instantiate one or more operations/functions that may correspond to at least some of the machine readable instructions of FIG. 2 and/or other desired operations. The logic gate circuitry 508 shown in FIG. 5 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 508 to enable configuration of the electrical structures and/or the logic gates to form circuits to perform desired operations/functions. The logic gate circuitry 508 may include other electrical structures such as look-up tables (LUTs), registers (e.g., flip-flops or latches), multiplexers, etc.

The configurable interconnections 510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 508 to program desired logic circuits.

The storage circuitry 512 of the illustrated example is structured to store result(s) of the one or more of the operations performed by corresponding logic gates. The storage circuitry 512 may be implemented by registers or the like. In the illustrated example, the storage circuitry 512 is distributed amongst the logic gate circuitry 508 to facilitate access and increase execution speed.

The example FPGA circuitry 500 of FIG. 5 also includes example dedicated operations circuitry 514. In this example, the dedicated operations circuitry 514 includes special purpose circuitry 516 that may be invoked to implement commonly used functions to avoid the need to program those functions in the field. Examples of such special purpose circuitry 516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 500 may also include example general purpose programmable circuitry 518 such as an example CPU 520 and/or an example DSP 522. Other general purpose programmable circuitry 518 may additionally or alternatively be present such as a GPU, an XPU, etc., that can be programmed to perform other operations.

Although FIGS. 4 and 5 illustrate two example implementations of the programmable circuitry 312 of FIG. 3, many other approaches are contemplated. For example, FPGA circuitry may include an on-board CPU, such as one or more of the example CPU 520 of FIG. 4. Therefore, the programmable circuitry 312 of FIG. 3 may additionally be implemented by combining at least the example microprocessor 400 of FIG. 4 and the example FPGA circuitry 500 of FIG. 5. In some such hybrid examples, one or more cores 402 of FIG. 4 may execute a first portion of the machine readable instructions represented by the flowchart of FIG. 2 to perform first operation(s)/function(s), the FPGA circuitry 500 of FIG. 5 may be configured and/or structured to perform second operation(s)/function(s) corresponding to a second portion of the machine readable instructions represented by the flowchart of FIG. 2, and/or an ASIC may be configured and/or structured to perform third operation(s)/function(s) corresponding to a third portion of the machine readable instructions represented by the flowchart of FIG. 2.

It should be understood that some or all of the circuitry of FIGS. 1A and 1B may, thus, be instantiated at the same or different times. For example, same and/or different portion(s) of the microprocessor 400 of FIG. 4 may be programmed to execute portion(s) of machine-readable instructions at the same and/or different times. In some examples, same and/or different portion(s) of the FPGA circuitry 500 of FIG. 5 may be configured and/or structured to perform operations/functions corresponding to portion(s) of machine-readable instructions at the same and/or different times.

In some examples, some or all of the circuitry of FIGS. 1A and 1B may be instantiated, for example, in one or more threads executing concurrently and/or in series. For example, the microprocessor 400 of FIG. 4 may execute machine readable instructions in one or more threads executing concurrently and/or in series. In some examples, the FPGA circuitry 500 of FIG. 5 may be configured and/or structured to carry out operations/functions concurrently and/or in series. Moreover, in some examples, some or all of the circuitry of FIGS. 1A and 1B may be implemented within one or more virtual machines and/or containers executing on the microprocessor 400 of FIG. 4.

In some examples, the programmable circuitry 312 of FIG. 3 may be in one or more packages. For example, the microprocessor 400 of FIG. 4 and/or the FPGA circuitry 500 of FIG. 5 may be in one or more packages. In some examples, an XPU may be implemented by the programmable circuitry 312 of FIG. 3, which may be in one or more packages. For example, the XPU may include a CPU (e.g., the microprocessor 400 of FIG. 4, the CPU 520 of FIG. 5, etc.) in one package, a DSP (e.g., the DSP 522 of FIG. 5) in another package, a GPU in yet another package, and an FPGA (e.g., the FPGA circuitry 500 of FIG. 5) in still yet another package.

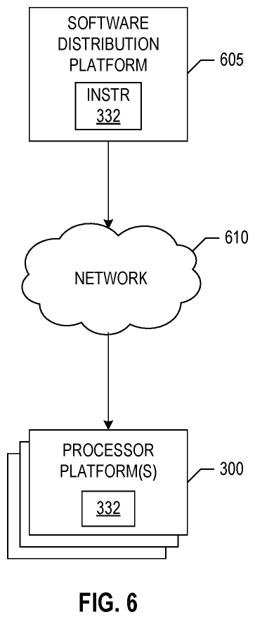

A block diagram illustrating an example software distribution platform 605 to distribute software such as the example machine readable instructions 332 of FIG. 3 to other hardware devices (e.g., hardware devices owned and/or operated by third parties from the owner and/or operator of the software distribution platform) is illustrated in FIG. 6. The example software distribution platform 605 may be implemented by any computer server, data facility, cloud service, etc., capable of storing and transmitting software to other computing devices. The third parties may be customers of the entity owning and/or operating the software distribution platform 605. For example, the entity that owns and/or operates the software distribution platform 605 may be a developer, a seller, and/or a licensor of software such as the example machine readable instructions 332 of FIG. 3. The third parties may be consumers, users, retailers, OEMs, etc., who purchase and/or license the software for use and/or re-sale and/or sub-licensing. In the illustrated example, the software distribution platform 605 includes one or more servers and one or more storage devices. The storage devices store the machine readable instructions 332, which may correspond to the example machine readable instructions of FIG. 2, as described above. The one or more servers of the example software distribution platform 605 are in communication with an example network 610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 332 from the software distribution platform 605. For example, the software, which may correspond to the example machine readable instructions of FIG. 2, may be downloaded to the example programmable circuitry platform 300, which is to execute the machine readable instructions 332 to implement the comparison circuitry 108. In some examples, one or more servers of the software distribution platform 605 periodically offer, transmit, and/or force updates to the software (e.g., the example machine readable instructions 332 of FIG. 3) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that overcome the inaccuracies of traditional neural network attention frameworks and/or modules that attempt to distinguish between two or more sentences and/or phrases. As discussed above, typical semantic comparison approaches fail when even small deviations occur in text and/or sentence terminology, whether such deviations are due to typographical errors or shorthand notation differences between same/similar items. As such, technical solutions disclosed herein improve similarity assessment accuracy and, in some cases, improves patient safety by correctly determining similarities between administered medications.

Example methods, apparatus, systems, and articles of manufacture for lexical analysis are disclosed herein. Further examples and combinations thereof include the following:

Example 1 includes an apparatus to improve similarity assessment accuracy comprising interface circuitry, machine readable instructions, and programmable circuitry to at least one of instantiate or execute the machine readable instructions to encode tokens with token semantic characteristics, encode the tokens with token lexical characteristics to generate encoded tokens, respective ones of the encoded tokens including at least one of the semantic characteristics and at least one of the lexical characteristics, and identify a match between two of the encoded tokens.

Example 2 includes the apparatus as defined in example 1, wherein the programmable circuitry is to transmit the at least two of the encoded tokens to a self attention network to generate a probability value.

Example 3 includes the apparatus as defined in example 2, wherein the self attention network is to normalize an output of the self attention network to generate the probability value.

Example 4 includes the apparatus as defined in example 1, wherein the programmable circuitry is to calculate a pair-wise compatibility metric between first ones of the tokens from a first sentence and second ones of the tokens from a second sentence.

Example 5 includes the apparatus as defined in example 4, wherein the programmable circuitry is to calculate the pair-wise compatibility metric as a Levenshtein distance.

Example 6 includes the apparatus as defined in example 4, wherein the programmable circuitry is to set the pair-wise compatibility metric between the first ones of the tokens to zero, and set the pair-wise compatibility metric between the second ones of the tokens to zero.

Example 7 includes the apparatus as defined in example 4, wherein the programmable circuitry is to tokenize words of the first sentence and words of the second sentence to generate the first tokens and the second tokens, respectively.

Example 8 includes the apparatus as defined in example 1, wherein the programmable circuitry is to identify the match by generating a probability value corresponding to the respective ones of the encoded tokens.

Example 9 includes an apparatus comprising position encoding circuitry to encode tokens with token semantic characteristics, lexical encoding circuitry to encode the tokens with token lexical characteristics, respective ones of the tokens including at least one of the semantic characteristics and at least one of the lexical characteristics, and self attention circuitry to identify a match between two of the encoded tokens.

Example 10 includes the apparatus as defined in example 9, wherein the position encoding circuitry is to transmit first encoded tokens having semantic characteristics to the self attention circuitry, and the lexical encoding circuitry is to transmit second encoded tokens having lexical characteristics to the self attention circuitry, the self attention circuitry to calculate a probability value based on the first and second encoded tokens.

Example 11 includes the apparatus as defined in example 10, wherein the self attention circuitry is to normalize an output to generate the probability value.

Example 12 includes the apparatus as defined in example 9, further including cross encoder circuitry to calculate a pair-wise compatibility metric between first ones of the tokens from a first sentence and second ones of the tokens from a second sentence.

Example 13 includes the apparatus as defined in example 12, wherein the lexical encoding circuitry is to calculate the pair-wise compatibility metric as a Levenshtein distance.

Example 14 includes the apparatus as defined in example 12, wherein the cross encoder circuitry is to set the pair-wise compatibility metric between the first ones of the tokens to zero, and set the pair-wise compatibility metric between the second ones of the tokens to zero.

Example 15 includes the apparatus as defined in example 9, wherein the self attention circuitry is to identify the match by generating a probability value corresponding to the two of the encoded tokens.

Example 16 includes a non-transitory machine readable storage medium comprising instructions to cause programmable circuitry to at least encode tokens with token semantic characteristics, encode the tokens with token lexical characteristics to generate encoded tokens, respective ones of the encoded tokens including at least one of the semantic characteristics and at least one of the lexical characteristics, and identify a match between two of the encoded tokens.

Example 17 includes the non-transitory storage medium as defined in example 16, wherein the programmable circuitry is to transmit the at least two of the encoded tokens to a self attention network to generate a probability value.

Example 18 includes the non-transitory storage medium as defined in example 17, wherein the programmable circuitry is to normalize an output of the self attention network to generate the probability value.

Example 19 includes the non-transitory storage medium as defined in example 16, wherein the programmable circuitry is to calculate a pair-wise compatibility metric between first ones of the tokens from a first sentence and second ones of the tokens from a second sentence.

Example 20 includes the non-transitory storage medium as defined in example 19, wherein the programmable circuitry is to calculate the pair-wise compatibility metric as a Levenshtein distance.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to improve similarity assessment accuracy comprising:
interface circuitry;
machine readable instructions; and
programmable circuitry to at least one of instantiate or execute the machine readable instructions to:
encode tokens with token semantic characteristics;
encode the tokens with token lexical characteristics to generate encoded tokens, respective ones of the encoded tokens including at least one of the semantic characteristics and at least one of the lexical characteristics; and
identify a match between two of the encoded tokens.

2. The apparatus as defined in claim 1, wherein the programmable circuitry is to transmit the at least two of the encoded tokens to a self attention network to generate a probability value.

3. The apparatus as defined in claim 2, wherein the self attention network is to normalize an output of the self attention network to generate the probability value.

4. The apparatus as defined in claim 1, wherein the programmable circuitry is to calculate a pair-wise compatibility metric between first ones of the tokens from a first sentence and second ones of the tokens from a second sentence.

5. The apparatus as defined in claim 4, wherein the programmable circuitry is to calculate the pair-wise compatibility metric as a Levenshtein distance.

6. The apparatus as defined in claim 4, wherein the programmable circuitry is to:
set the pair-wise compatibility metric between the first ones of the tokens to zero; and
set the pair-wise compatibility metric between the second ones of the tokens to zero.

7. The apparatus as defined in claim 4, wherein the programmable circuitry is to tokenize words of the first sentence and words of the second sentence to generate the first tokens and the second tokens, respectively.

8. The apparatus as defined in claim 1, wherein the programmable circuitry is to identify the match by generating a probability value corresponding to the respective ones of the encoded tokens.

9. An apparatus comprising:
position encoding circuitry to encode tokens with token semantic characteristics;
lexical encoding circuitry to encode the tokens with token lexical characteristics, respective ones of the tokens including at least one of the semantic characteristics and at least one of the lexical characteristics; and
self attention circuitry to identify a match between two of the encoded tokens.

10. The apparatus as defined in claim 9, wherein:
the position encoding circuitry is to transmit first encoded tokens having semantic characteristics to the self attention circuitry; and
the lexical encoding circuitry is to transmit second encoded tokens having lexical characteristics to the self attention circuitry, the self attention circuitry to calculate a probability value based on the first and second encoded tokens.

11. The apparatus as defined in claim 10, wherein the self attention circuitry is to normalize an output to generate the probability value.

12. The apparatus as defined in claim 9, further including cross encoder circuitry to calculate a pair-wise compatibility metric between first ones of the tokens from a first sentence and second ones of the tokens from a second sentence.

13. The apparatus as defined in claim 12, wherein the lexical encoding circuitry is to calculate the pair-wise compatibility metric as a Levenshtein distance.

14. The apparatus as defined in claim 12, wherein the cross encoder circuitry is to:
set the pair-wise compatibility metric between the first ones of the tokens to zero; and
set the pair-wise compatibility metric between the second ones of the tokens to zero.

15. The apparatus as defined in claim 9, wherein the self attention circuitry is to identify the match by generating a probability value corresponding to the two of the encoded tokens.

16. A non-transitory machine readable storage medium comprising instructions to cause programmable circuitry to at least:
encode tokens with token semantic characteristics;
encode the tokens with token lexical characteristics to generate encoded tokens, respective ones of the encoded tokens including at least one of the semantic characteristics and at least one of the lexical characteristics; and
identify a match between two of the encoded tokens.

17. The non-transitory storage medium as defined in claim 16, wherein the programmable circuitry is to transmit the at least two of the encoded tokens to a self attention network to generate a probability value.

18. The non-transitory storage medium as defined in claim 17, wherein the programmable circuitry is to normalize an output of the self attention network to generate the probability value.

19. The non-transitory storage medium as defined in claim 16, wherein the programmable circuitry is to calculate a pair-wise compatibility metric between first ones of the tokens from a first sentence and second ones of the tokens from a second sentence.

20. The non-transitory storage medium as defined in claim 19, wherein the programmable circuitry is to calculate the pair-wise compatibility metric as a Levenshtein distance.
